(19) United States
(12) Patent Application Publication
(10) Pub. No.: US 2004/0061249 A1
(43) Pub. Date: Apr. 1, 2004

(54) Injection molding, method for producing injection molding and die for injection molding

(76) Inventors: Takao Umezawa, Ota-shi (JP); Yousuke Fukasawa, Ota-shi (JP); Katsuo Matsunaga, Ota-shi (JP); Hitoshi Konuma, Ota-shi (JP); Yoshihiro Takahashi, Ota-shi (JP)

Correspondence Address: Oliff & Berridge, PO Box 19928, Alexandra, VA, 22320, US

(21) Appl. No.: 10/415,980

(22) PCT Filed: Sep. 13, 2001
(86) PCT No.: PCT/JP01/07973

(30) Foreign Application Priority Data
Nov. 10, 2000 (JP) 2000-343318

(51) Int. Cl. B29C 45/14

(52) U.S. Cl. 264/2.5; 425/542; 425/149; 264/255

(57) ABSTRACT

In order to eliminate post-molding mounting of a bulb 3 and a terminals 7 using a socket, when molding of a side turn signal blinker 1 in a manner of die slide injection, a process to mount the bulb 3 and the terminals 7 to a housing 4 is provided between a process to separate a first and second dies 9 and 10 from each other, which has carried out a primary injection molding of a lens portion 2 and the housing 4 as semi-finished products, and a process in which the dies are slid, the lens portion 2 and the housing 4 are butted and the secondary injection is carried out; thereby post-molding mounting of the bulb and the terminals is eliminated and the side turn signal blinker 1 in which the bulb 3 and the terminals 7 have been inserted, is obtained.

### TECHNICAL FIELD

The present invention relates to a technical field of various injection molded articles, which are formed in a manner of injection molding such as side turn signal blinker, headlights and taillights mounted on vehicles, a manufacturing method of injection molded articles and a set of dies for injection molding.

### BACKGROUND ART

Generally, as one of these injection molded articles, a side turn signal blinker, which is provided so that the turning direction of a vehicle is visually recognized from the side of the vehicle body, is exemplified. The following description will be made taking a side turn signal blinker as an example. Some conventional side turn signal blinkers are formed in such a manner that a lens portion and a housing, in which a bulb as an electric part having terminals is mounted, are molded as semi-finished products respectively, and then, these semi-finished products are butted and bonded to each other. As a manufacturing method of an article as described above, a die slide injection method is known. This method is set forth, for example, in Japanese Examined Patent Publication No. H-02-38377. When a side turn signal blinker is molded using the above method, in a state that a movable die and a fixed die are disposed facing each other, a lens portion and a housing are respectively shaped and molded as primary products (primary molding). These primary products are butted to each other by moving the movable die in a sliding manner. Then, secondary injection of a resin material is carried out into a groove formed on the outer periphery of the butted surfaces. Thus, a hollow casing is shaped and molded (secondary molding).

However, in the above-described side turn signal blinker, it is necessary to mount a bulb as a part to the casing. In the above-described conventional method, a housing is formed with an opening for mounting a socket attached with a bulb. A casing is molded by fixedly attaching a lens portion to the housing. And then, the socket with the bulb is mounted afterward in a manner of, for example, bonding or twisting (turn-to-fix), or the like. Therefore, the method, which adopts the above-described technique, has the following problems; i.e., since a separated socket is required, not only is the number of parts increased but also a process for mounting the socket is required. Further, in the above method, when waterproofing to prevent water from invading the casing is required, another problem arises; i.e., a sealing member (for example, O-ring) must be interposed between the socket and the opening. Thus, the present invention has been proposed to solve the above-described problems.

### DISCLOSURE OF THE INVENTION

The present invention has been proposed in view of solving the above-described problems. A first aspect of the invention is a manufacturing method of an injection molded article, which includes the steps of molding a plurality of semi-finished products respectively by a primary injection, butting the molded semi-finished products, and carrying out a secondary injection on the butted portion to integrate the molded semi-finished products, wherein a process in which an electric part is mounted to a part mounting portion of at least one semi-finished product formed in the primary injection is provided between the primary injection process and the butting process.

Further, a second aspect of the invention is an injection molded article structured by molding a plurality of semi-finished products respectively by a primary injection, after butting the molded semi-finished products, carrying out a secondary injection on the butted portion to integrate the molded semi-finished products, wherein a mounting portion for mounting an electric part is integrally formed in at least one semi-finished product molded by the primary injection.

Furthermore, a third aspect of the invention is a set of dies for an injection molded article for integrally forming an injection article by molding a plurality of semi-finished products respectively by a primary injection, mounting a part to at least one of the molded semi-finished products, and then butting the semi-finished products to each other and carrying out a secondary injection on the butted portion, wherein, in the dies to mold the semi-finished products in the primary injection, a mounting-portion mold for forming a mounting portion for the part is formed.

Herein, the dies are characterized in that the part which is mounted to the semi-finished products is an electric part having terminals, in the dies to mold the semi-finished products in the primary injection, in addition to the mounting-portion mold for forming the mounting portion for the electric part, an insertion hole mold for forming insertion holes for the terminals protruding from said electric part and a regulating portion for regulating injection of the primary injection material into the insertion hole mold in the primary injection process are formed.

Owing to the above-described arrangement, in the present invention an injection molded article integrated with a part can be manufactured easily in a manner of die slide processing. As a result, not only does a socket, O-ring or the like become unnecessary but also the post-molding mounting of a part can be eliminated.

### BRIEF DESCRIPTION OF DRAWINGS

FIG. 1 is a side view of a side turn signal blinker.

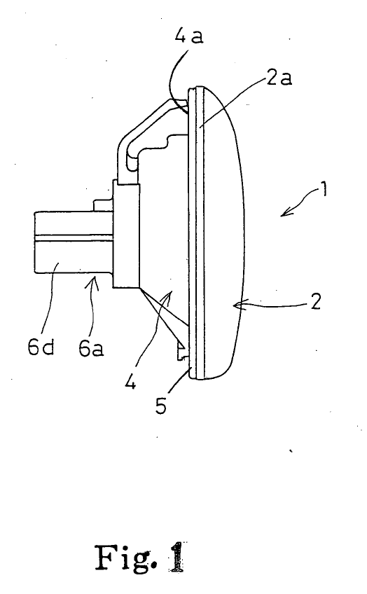

FIG. 2 is a bottom view of the side turn signal blinker.

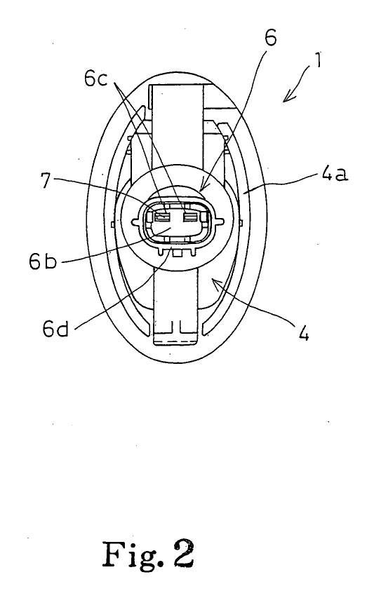

FIG. 3 is a cross-sectional view of the side turn signal blinker.

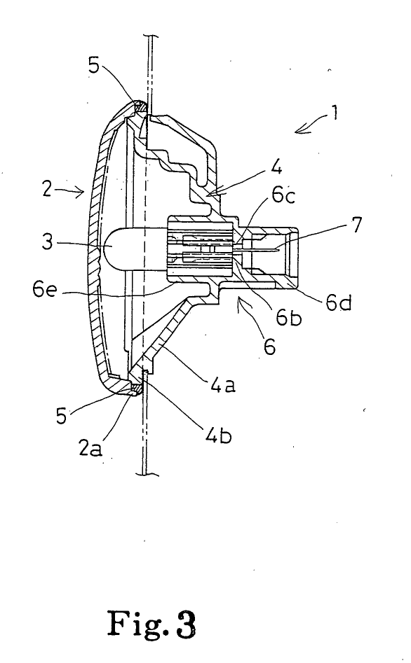

FIG. 4 is a vertical sectional view of the side turn signal blinker.

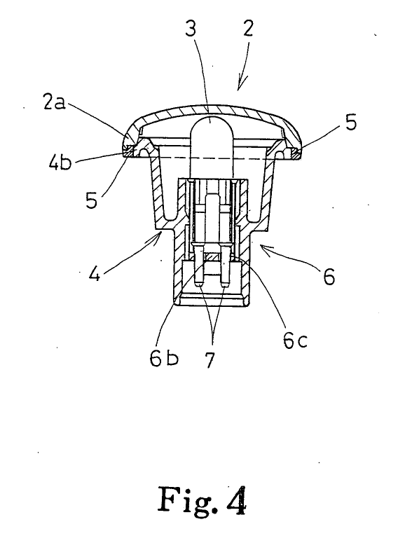

FIGS. 5 (A)-(E) are enlarged sectional views showing embodiments of molding portions in a partitioning portion of a housing. FIG. 5(F) is a sectional view of the housing, and the portion marked with a circle is a partitioning portion.

FIGS. 6 (A)-(C) are explanatory views schematically showing a first half process state of a die slide injection.

FIGS. 7 (A)-(D) are explanatory views schematically showing a second half process state of the die slide injection.

FIG. 8(A) is an enlarged vertical sectional view of a bulb mounting portion of a housing, FIG. 8(B) is an enlarged cross-sectional view thereof, FIG. 8(C) is an enlarged plan view of the bulb mounting portion of the housing, FIG. 8(D) is an enlarged side view of a state in which the bulb and the terminals are mounted, and FIG. 9(E) is an elevation view thereof.

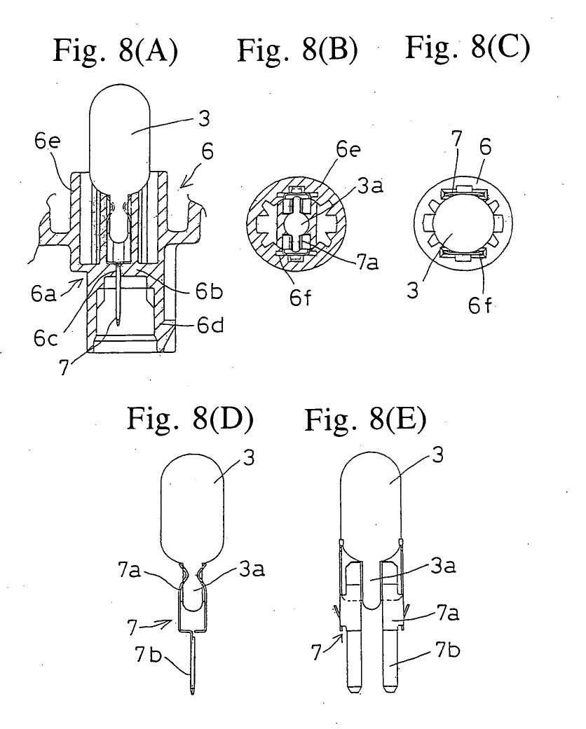

FIG. 9 is an explanatory view schematically showing a process of the die slide injection according to a second embodiment.

### BEST MODE FOR CARRYING OUT THE INVENTION

Now, embodiments of the present invention will be described with reference to the drawings. In the figures, reference numeral 1 denotes a side turn signal blinker. The side turn signal blinker 1 comprises a lens portion 2 and a housing 4 in which a bulb 3 is mounted. The lens portion 2 and the housing 4 are molded in a manner of die slide injection as described below. That is, the lens portion 2 and the housing 4 are molded as primary products (semi-finished product), which are halved products, by means of primary injection molding by butting a fixed die and a movable die to each other; and then, the movable die is moved in a sliding manner to butt the primary products to each other; and then, secondary injection of a resin material 5 is made between the butted surfaces. As for the die slide injection method, since it is a conventionally well-known method, detailed description on the structure of the die shift mechanism and the like will be omitted.

The lens portion 2, which is formed in a manner of the above-described primary injection molding, is formed into a bowl-like shape, and the opening end periphery portion 2a thereof is formed substantially flat. On the other hand, the housing 4 is integrally formed from a socket portion (mounting portion) 6 (to be described later), to which the bulb 3 is mounted, and a flange portion 4a, which protrudes in a bowl-like shape in the horizontal (right-and-left) direction from the outer periphery of the socket portion 6. It is arranged so that the opening end periphery portion 4b of the flange portion 4a is butted to the opening end periphery portion 2a in a manner of face-to-face contact, and a secondary injection of a resin material 5 is made on the corner portion between the butted surfaces to integrate both.

The socket portion 6 is formed from a cylindrical portion 6a that is formed so as to protrude inward and outward with respect to the housing 4, and a partitioning portion 6b that partitions the cylindrical portion 6a. Further, formed on the partitioning portion 6b are through holes 6c for allowing a pair of terminals 7, which are connected to the bulb 3, to pass through. In the cylindrical portion 6a, a portion 6d more outward than the partitioning portion 6b is adapted so as to be fitted with a power supply connector 8. On the other hand, in the cylindrical portion 6a, formed on the portion 6e more inward than the partitioning portion 6b is a terminal support portion 6f for allowing the terminals 7 to insert therethrough and support the same. The terminals 7 and the bulb 3 are mounted to the housing 4 in a process between the primary injection process (to be described later) and a process in which the lens portion 2 and the housing 4 are butted to each other. In this embodiment, since the terminals 7 and the bulb, which are separated from each other, are adopted, the pair of terminals 7 are inserted to mount from the inside of the housing; and then, the bulb base end portion 3a is fitted into a bulb holding portion 7a, which is formed in the terminals 7, and thus, attached thereto. In this embodiment, the bulb 3 and the terminals 7, which are separated from each other, are used. However, an assembly of the bulb and terminals, which have been integrated beforehand, may be used. In this case, an assembly thereof is only attached.

Reference numerals 9 and 10 denote a set of dies used for die slide injection, which is adopted in this embodiment. Here, the dies comprise a first die 9, which is a fixed die, and a second die 10, which is adopted so as to be movable vertically and transversely with respect to the first die 9. Between the first die 9 and the second die 10, a mold for forming a lens portion 2 and a mold for forming a housing 4 in the primary injection process are formed respectively. The mold for forming the housing 4 is arranged as described below. In this embodiment, the first die 9 molds the outer surface portion of the housing 4, and the second die 10 molds the inner surface portion of the housing 4. On these dies 9 and 10, molding portions for forming the socket portion 6 are formed respectively. Further, in the first die 9, an insertion hole 9a for allowing the front-end portions 7b, which protrude outward from the partitioning portion 6b of the above-described terminals 7, to be inserted thereinto to support the same is formed. On the other hand, formed into a convex shape on the second die 10 is an inject-regulating portion 10a for regulating injection of the primary injection material into the above-described supporting hole 9a, by sealing the supporting hole 9a when the primary injection is carried out.

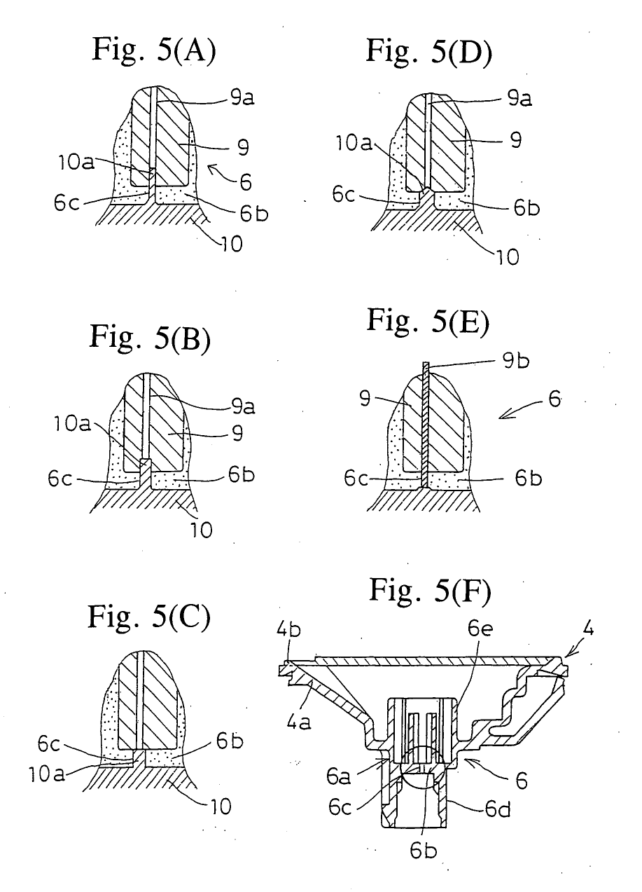

FIGS. 5(A)-5(E) show examples of the above-described inject-regulating portion 10a. FIG. 5(A) shows an example in which the thickness of the regulating portion 10a is set to be the same as the inner dimension of the insertion hole 9a, and is adapted so as to be inserted beyond the partitioning portion 6b. FIG. 5(B) shows an example in which the thickness of the regulating portion 10a is larger than the inner dimension of the insertion hole 9a, and is adapted so as to be inserted beyond the partitioning portion 6b. FIG. 5(C) shows an example in which the thickness of the regulating portion 10a is larger than the inner dimension of the insertion hole 9a, and is adapted so as to be inserted up to the point of the outer surface of the partitioning portion 6b. FIG. 5(D) shows an example in which the front end portion of the regulating portion 10a having a larger thickness than the inner dimension of the insertion portion 9a is formed into a chevron-shape (tapered spiral-like shape), and is adapted so that the front end portion thereof comes into face-to-face contact with the corresponding portion of the first die 9. These arrangements are for preventing the resin material from entering into the insertion hole 9a while carrying out the primary injection, and any one of the above may be adopted. Furthermore, as shown in FIG. 5(E), this embodiment can be also carried out with such an arrangement that a pin (or plate)-like movable die 9b, which enters into/retracts from the insertion hole 9a, is provided to the first die 9 in place of the regulating portion 10a.

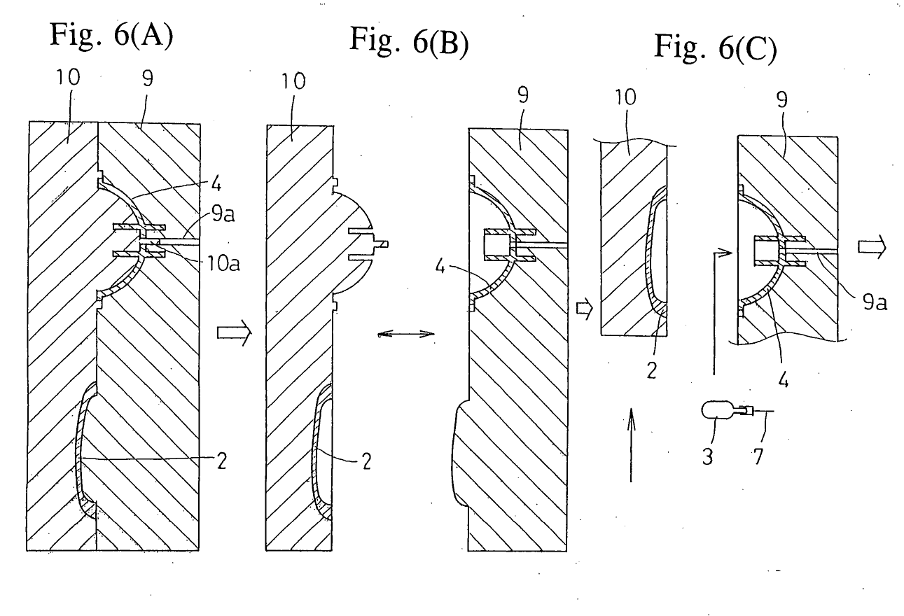

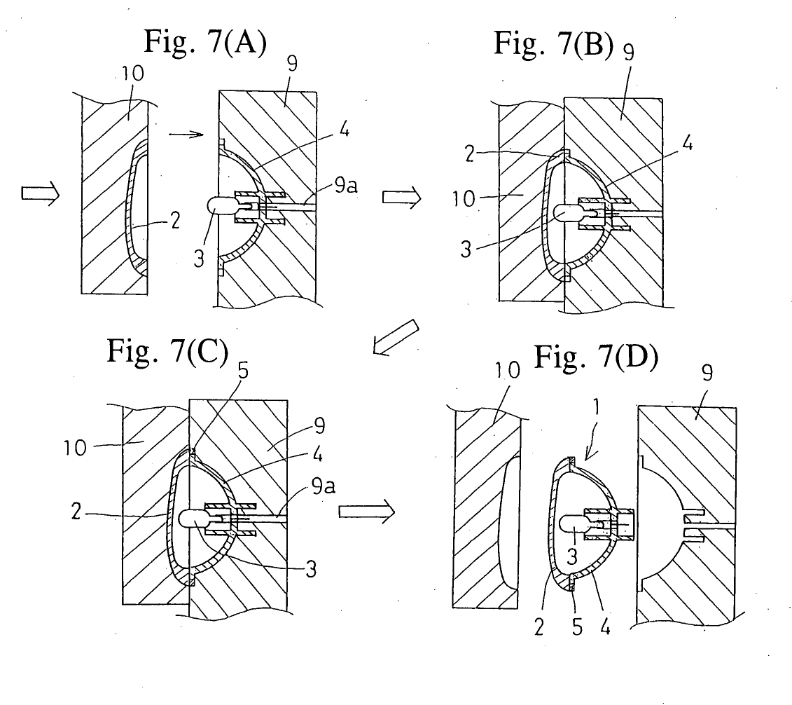

FIG. 6 and FIG. 7 show the molding procedures in a manner of the die slide injection with which the present invention is carried out. First, as shown in FIG. 6(A), the primary injection is carried out in a state that the first and second dies 9 and 10 are butted with each other, thereby the lens portion 2 and the housing 4 are shaped and molded as semi-finished products. Then, as shown in FIG. 6(B), these dies 9 and 10 are separated from each other. Here, the housing 4 is die-cut on the first die 9; the lens portion 2 is die-cut on the second die 10 in a state of die-matching. After that, as shown in FIG. 6(C), a die shift is carried out so that the lens portion 2 and the housing 4 face each other. According to this embodiment, as shown in FIG. 7(A), in this step, the terminals 7 and bulb 3 are mounted to the housing 4. Then, as shown in FIG. 7(B), the first die 9 and the second die 10 are butted to each other so that the housing 4 and the lens portion 2 are butted to each other. After that, as shown in FIG. 7(C), a secondary injection of the resin material 5 is carried out in the butted portion. Then, as shown in FIG. 7 (D), a die-cutting is carried out to obtain a finished side turn signal blinker 1.

Here, the terminals 7 and bulb 3 may be mounted to the housing at any time between the process where the dies 9 and 10 are separated from each other after the first injection shown in FIG. 6 (B) and the process where the housing 4 and the lens portion 2 are butted as shown in FIG. 7 (B). The above is appropriately selectable on the basis of the conditions. Also, as for the shift of the dies 9 and 10, when the primary products are butted to each other before the secondary injection, a relative movement will do. Accordingly, the relationship of the movements between the dies 9 and 10 described above may be inverted; or both of the dies may be moved. As a matter of course, any of the above may be appropriately selectable on the basis of the conditions.

In the structure as described above, the lens portion 2 and the housing 4 are shaped and molded by the primary injection process. Then, after the lens portion 2 and the housing 4 are butted to each other, secondary injection of the resin material 5 is made on the butted portion therebetween to integrate them. But it should be noted that the bulb 3 and the terminals 7 are not mounted afterward by using a socket, which is a separated member, but are mounted to the socket portion 6, which is formed integrally with the housing 4, from the inside of the housing 4 between the process after the primary injection and the process before both are butted. After that, the lens portion 2 and the housing 4 are butted to each other and the secondary injection is carried out. As a result, since the socket into which the bulb 3 and the terminals 7 have been inserted is not required as a separated member, the number of parts can be reduced and the mounting process of the socket is eliminated, resulting in a cost reduction. Further, in this case, the socket portion 6 is molded integrally with the housing 4. Accordingly, unlike the case that the socket is mounted afterward, since no waterproofing measures for the relevant portion are required, any O-ring or sealing member for waterproof is not required.

Furthermore, in this embodiment, the through holes 6c for allowing the terminals 7 to project outward are formed in the socket portion 6 of the housing 4 in the primary injection process. On the other hand, the insertion hole 9a for inserting the terminal front end portions 7b, which protrude outward, in the second injection process is formed in the first die 9; thereby the insertion and mounting of the bulb 3 and the terminals 7 can be carried out sequentially in the die slide injection process.

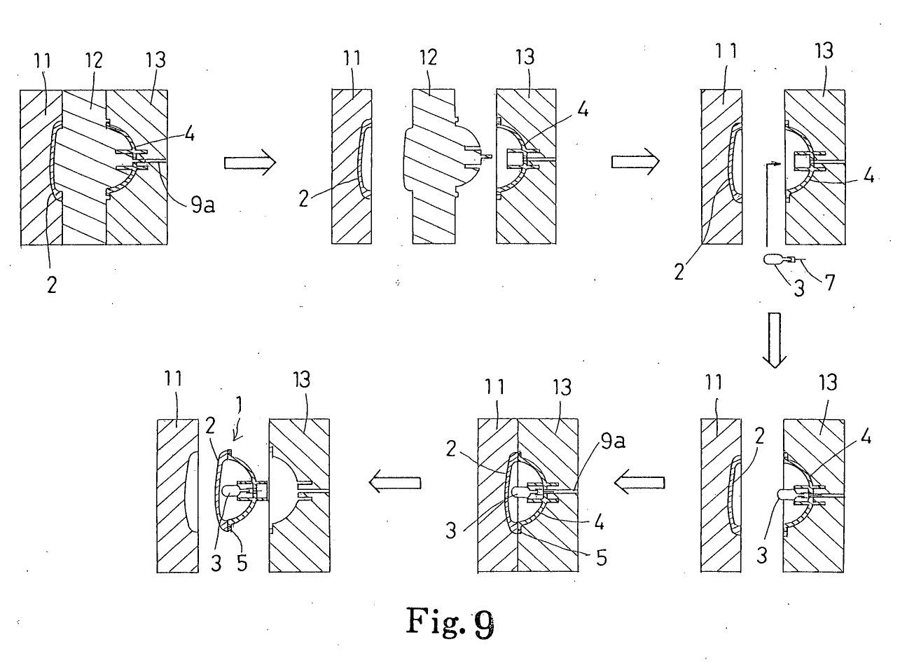

As a matter of course, the present invention is not limited to the die slide injection method in which the above-described first and second dies are used. The present invention is also applicable to a second embodiment shown in FIG. 9. Using a first, second and third dies 11, 12 and 13, the lens portion 2 is molded by the first and second dies 11 and 12; and the housing 4 is molded by the second and third dies 12 and 13 in the first injection process. After separating these dies 11, 12 and 13, the second die 12 is removed therefrom. Then, the first and the third dies 11 and 13 are butted to each other, and a second injection is carried out to integrate the lens portion 2 and the housing 4 to obtain a lamp body. In this case, the mounting of the bulb 3 to the housing 4 can be carried out between the process where the primary injection has completed and each of the dies 11, 12 and 13 are separated from each other and the process where the lens portion 2 and the housing 4 are butted to each other before carrying out the secondary injection.

Further, although a side turn signal blinker, which is one of the lamps, has been described in the first and second embodiments, it is a matter of course that the present invention is not limited to lamp bodies. The present invention is applicable to a part, which is mounted within a molded article, particularly, it is preferably applicable to a part, terminals of which for external connection such as a relay, projects out of its body. Irrespective of the external connection method of the terminals, the present invention can be applicable to an article as a semi-finished product, which comprises, in a case where the terminals are relays, a relay base to which a bobbin wound with a coil is mounted as an electric part and a relay cover which is bonded to the relay base so as to cover the coil bobbin. Furthermore, as for the number of parts, which are internally mounted, it is not limited to one. It is a matter of course that the number of the parts may be plural.

Industrial Applicability

According to the present invention, a plurality of semi-finished products are molded in the primary injection process. And after butting these semi-finished products, the secondary injection of the resin material is made to integrate them, wherein a part is not mounted to one of the semi-finished products in a manner of post-molding mounting, but it is mounted to a part mounting portion formed integrally with one of the semi-finished products from the inside of one of the semi-finished products, in a process after the primary injection process and before carrying out the butting of them. Subsequently, the semi-finished products are butted and a secondary injection is carried out. Accordingly, since a separated mounting member is not required, the number of parts can be reduced and the mounting process of the part is eliminated resulting in a cost reduction. Further, unlike the method in which the part is mounted in a manner of post-molding mounting, no waterproofing measures for the related portion are required resulting in an elimination of a waterproofing O-ring or sealing member. Particularly, in a case where the mounting part is a bulb or a terminal, a through hole for allowing the terminal to project outward is formed in the socket portion of the housing in the primary injection process, and on the other hand, an insertion hole for inserting the terminal front end portion, which projects outward, is formed in the first die in the secondary injection process. Owing to this arrangement, the bulb or terminal can be mounted sequentially in a die slide injection process.

1. A manufacturing method of an injection molded article, comprising the steps of; molding a plurality of semi-finished products respectively by a primary injection, butting said molded semi-finished products, and carrying out a secondary injection on the butted portion to integrate said molded semi-finished products, wherein a process in which a part is mounted to a part mounting portion of at least one semi-finished product formed in said primary injection is provided between said primary injection process and said butting process.

2. An injection molded article structured by molding a plurality of semi-finished products respectively by a primary injection, butting said molded semi-finished products, and then carrying out a secondary injection on the butted portion to integrate said molded semi-finished products, wherein a mounting portion for mounting a part is integrally formed in at least one semi-finished product molded by said primary injection.

3. A set of dies for an injection molded article for integrally forming an injection article by molding a plurality of semi-finished products respectively by a primary injection, mounting a part to at least one of the molded semi-finished products, and then butting the semi-finished products to each other and carrying out a secondary injection on the butted portion, wherein, in the dies which mold the semi-finished products in said primary injection, a mounting-portion mold for forming a mounting portion for the part is formed.

4. A set of dies for an injection molded article according to claim 3, wherein the part which is mounted to the semi-finished products is an electric part having terminals, and in the dies to mold the semi-finished products in the primary injection, in addition to the mounting-portion mold for forming the mounting portion for the electric part, are formed an insertion hole mold for forming an insertion hole for the terminals protruding from said electric part and a regulating portion for regulating injection of the primary injection material into the insertion hole mold in the primary injection process.
